(19) United States
(12) Patent Application Publication
(10) Pub. No.: US 2003/0182155 A1
(43) Pub. Date: Sep. 25, 2003

(54) Method and apparatus for handling mail pieces that require special handling

(76) Inventors: David Nitzan, Palo Alto, CA (US); Gregory K. Myers, San Francisco, CA (US)

Correspondence Address: MOSER, PATTERSON & SHERIDAN L.L.P., 595 SHREWSBURY AVE, FIRST FLOOR, SHREWSBURY, NJ, 07702, US

(21) Appl. No.: 10/392,692

(22) Filed: Mar. 20, 2003

Related U.S. Application Data
(60) Provisional application No. 60/367,237, filed on Mar. 20, 2002.
(60) Provisional application No. 60/372,304, filed on Apr. 12, 2002.

(51) Int. Cl. G06F 17/60

(52) U.S. Cl. 705/1

(57) ABSTRACT

A system, apparatus and method for providing special handling service for a mail piece. More specifically, it relates to an approach for handling a mail piece that requires special handling services such as certificates of mailing, return receipt, registration, insurance, and similar types of special handling services via an automated self service unit.

This application claims the benefit of U.S. Provisional Applications No. 60/367,237 filed on Mar. 20, 2002 and No. 60/372,304 filed on Apr. 12, 2002, which are herein incorporated by reference.

The present invention relates to an apparatus and method for handling mail pieces that require special handling. More specifically, the present invention provides a new method and apparatus that handle mail requiring special handling such as certificates of mailing, return receipt, registration, insurance, and similar types of special handling.

### BACKGROUND OF THE DISCLOSURE

Customers often want to mail items and receive a receipt confirming that it was mailed, and/or that it was delivered. This type of service falls under the broad category of special handling services that is offered by the United States Postal Service (USPS). Special handling services may include services such as certificates of mailing, return receipt, registration, insurance and the like. Registered or certified mail service provided by the USPS renders several benefits, including proof of letter mailing, letter tracking, letter-delivery confirmation, and letter-delivery verification (“return receipt”).

However, the usage of special handling services is currently impeded by several major drawbacks. First, special handling services can only be provided by going to a post office during normal operating hours and interacting with a postal clerk, i.e., standing in line, and filling out forms. If a delivery confirmation is desired, the sender must also fill out his address on a postcard. Second, special handling services are expensive (e.g., $7.50 for letter registration, not counting first class postage, a return-receipt fee, and other optional charges).

These drawbacks cause many people to underutilize special handling services and rely on regular mail for sending valued letters (e.g., containing payment checks), even though there is a risk that these letters will be lost or stolen. When this occurs, the sender may file a lost/stolen-letter report to the USPS Postal Inspection Office, which will investigate the case but will not reimburse the sender if there is any monetary loss. In turn, the sender becomes frustrated and angry because the sender cannot prove that he/she has mailed that letter, usually by dropping it into a USPS collection box.

Therefore, a need exists for a method and an apparatus for providing the public with the benefits of special handling services by overcoming the time and cost drawbacks.

### SUMMARY OF THE INVENTION

The present invention is a system, apparatus and method for providing special handling service for a mail piece. More specifically, it relates to an approach for handling a mail piece that requires special handling services such as certificates of mailing, return receipt, registration, insurance, and similar types of special handling services via an automated self service unit.

In one embodiment, the present invention employs an automated mail-piece registration unit (AMRU). The automated mail-piece registration unit may comprise a processor, Input/Output devices, mail piece handling device, a secure container, an image capturing device, one or more printers, a memory, a scale, and a communication channel.

In brief, the AMRU is a kiosk-like, self-service unit. This automated unit will enable the public at large, both individuals and businesses, to avoid the current time/cost drawbacks by using the AMRU to mail important letters to each other. Urban and rural distribution of AMRUs will overcome the time constraint of interacting with a postal employee during normal business hours. These two factors will increase the volume of registered letters, which, in turn, will lower the cost of letter registration even further while increasing the USPS revenues and profits.

### BRIEF DESCRIPTION OF THE DRAWINGS

The teachings of the present invention can be readily understood by considering the following detailed description in conjunction with the accompanying drawings, in which:

FIG. 1 illustrates a flowchart of a method for identifying a mail piece for special handling;

FIG. 2 illustrates a mail piece bearing a stamp to indicate special handling;

FIG. 3 illustrates a flowchart of a method for handling a mail piece for special handling;

FIG. 4 illustrates a block diagram of a mail sorting system of the present invention;

FIG. 5 illustrates a block diagram of an automated mail-piece registration unit (AMRU) of the present invention; and

FIG. 6 illustrates a flowchart of a method for handling a mail piece for special handling using an AMRU of the present invention.

To facilitate understanding, identical reference numerals have been used, where possible, to designate identical elements that are common to the figures.

### DETAILED DESCRIPTION

The present invention relates to a system, including methods and apparatus, for the automated handling of a mail piece. More specifically, it relates to a system for handling a mail piece that requires special handling services such as certificates of mailing, return receipt, registration, insurance, and similar types of special handling services.

In brief, the approach of the present invention employs automated reading of the return address, sender's name, and/or email address on the mail piece, and automatic detection of one or more special stamps applied by the sender to the mail piece that specify the type of service. Thus, typical special handling services such as certified and registered mail can be mailed at any time without making a trip to the post office and without interacting with a clerk. The sender does not have to go to a postal service provider to obtain and fill out a special return notice postcard to be attached to the mail piece. This efficient method is extremely convenient for the sender and will ultimately increase usage of special handling services provided by the postal service provider. In turn, the higher volume of usage by consumers coupled with the automated features of the present approach will ultimately lower the cost in providing these special handling services.

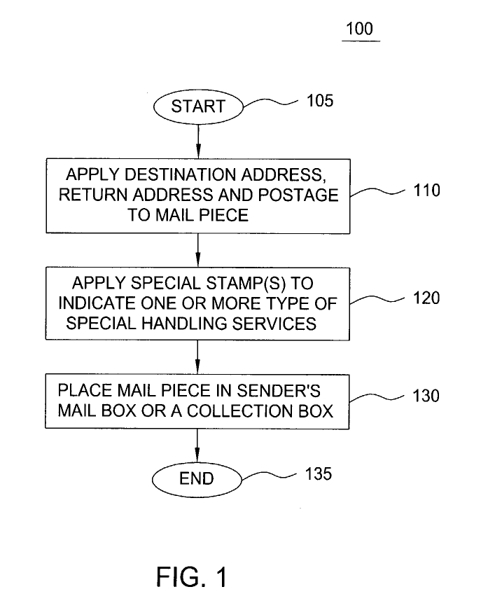

FIG. 1 illustrates a flowchart of a method 100 for identifying a mail piece for special handling. Method 100 starts in step 105 and proceeds to step 110.

In step 110, a sender applies a destination address, a return address and postage to a mail piece. For example, a sender will typically apply a destination address on the center of the envelope, a return address on the upper left-hand corner of the envelope and postage at the upper right-hand corner of the envelope. Although the term “mail piece” is described below pertaining to letter mail, those skilled in the art will realize that the present invention can be adapted to larger mail pieces, such as flats, parcels, and the like.

In step 120, one or more special stamps are applied to the mail piece to indicate that special handling is requested for the mail piece. The special stamps may indicate services such as certified mail, registered mail, return receipt, insurance, delivery confirmation, signature confirmation, notification of delivery information via email and similar types of special handling services.

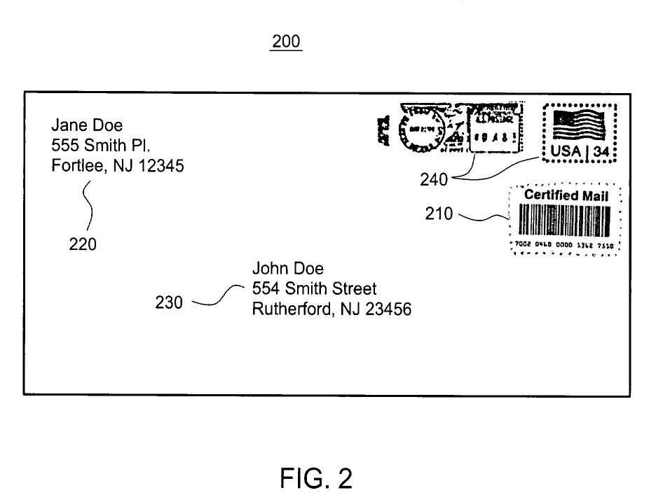

FIG. 2 illustrates a mail piece 200 bearing a special stamp 210 to indicate special handling. Namely, the sender applies one or more special stamps (previously purchased from a post office) that specify the type of service desired. In this instance, the special stamp 210 indicates certified mail as the requested special handling service. Other special stamps can be created to indicate registered mail, return receipt, delivery confirmation, signature confirmation, insurance (with different insurance denominations, e.g., $25, $50, $100 and so on). The special stamp may include a unique code, e.g., a bar code, to identify a particular type of special handling service or a combination of such handling types.

FIG. 2 also illustrates the typical locations for a destination address 230 near the center of the envelope, a return address 220 at the upper left-hand corner of the envelope and postage 240 on the upper right-hand side of the envelope. In FIG. 2, the special stamp is illustratively shown being applied along the upper right-hand side of the envelope. However, a particular “preferred” location for the placement of the special stamps can be defined by the postal service to assist in the detection of the presence of special stamps, e.g., at the lower right-hand or left-hand corner of the envelope or have the special stamp be applied such that the lines of its bar code are horizontal instead of vertical.

Returning to FIG. 1, in step 130, the mail piece is placed in the sender's mailbox or deposited in a collection box, where the mail piece is picked up by a US postal carrier. This efficient approach allows a sender to request special handling for a mail piece without having to travel to a post office. However, the special stamps have to be purchased in advance either at a post office or by mail. The sender also does not have to engage a complicated online interaction with a remote computer system or a website for each and every mail piece. The present process is similar to the simple method of applying postage to a mail piece.

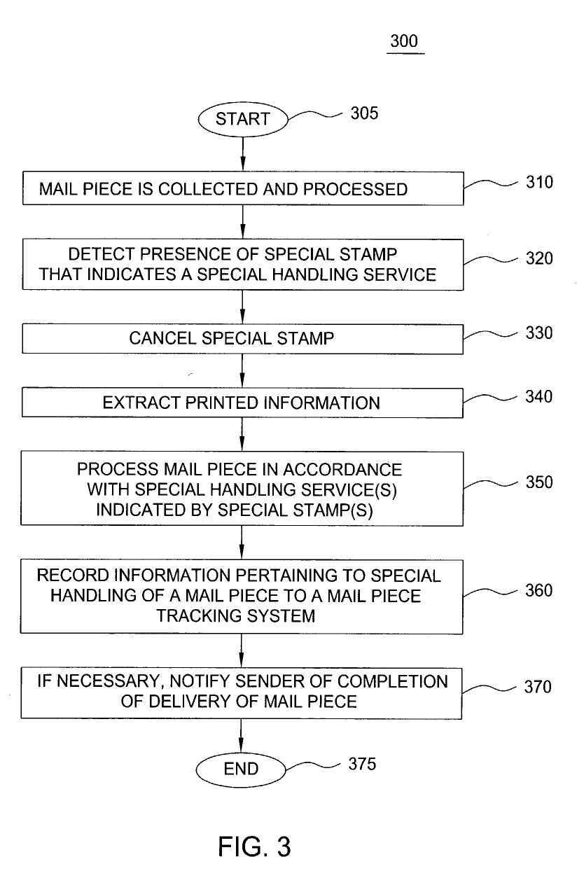

FIG. 3 illustrates a flowchart of a method 300 for handling a mail piece for special handling. Method 300 starts in step 305 and proceeds to step 310.

In step 310, the mail piece is first collected, namely, a carrier gathers the mail piece from the sender's mailbox or from a collection box. The mail piece is then processed by a mail-sorting machine.

In step 320, special stamps indicative of special handling types on the mail piece are detected. For example, the bar codes on the special stamps are detected and recorded as they are processed by the mail-sorting machine.

In step 330, the detected special stamps are canceled, so that they cannot be re-used.

In step 340, information printed on the mail piece is extracted. Specifically, an address recognition process locates and reads the destination address as usual, but if a special handling stamp is detected, the return address and return name are also located and read.

In step 350, the mail piece is processed in accordance with the requested special handling. For example, a barcode containing a unique ID (e.g., an RBCS ID code) is printed on the mail piece. Thus, it should be noted that a unique code can be omitted on the special stamp and instead can be printed directly onto the mail piece after the special stamp is detected during the mail-sorting process. It should also be noted that the unique ID code can be read at various sorting points along its route to the destination address, and its presence at these sort points can be recorded in the mail piece tracking system as disclosed in step 360.

In step 360, a record of the destination and return address information (in the form of recognized text and/or pixels in the scanned image of the mail piece), processing location, and date and time is stored and eventually uploaded to a mail piece tracking system. Namely, the mail piece tracking system has the ability to detect and track mail pieces that require special handling.

In step 370, the mail piece is delivered and, if necessary, the sender is notified of the delivery. For example, if delivery confirmation is desired, the carrier (a person who delivers the mail piece) scans the ID code with a portable unit 490 when the item is delivered. If signature confirmation of delivery is desired, the receiver of the mail piece signs on a portable electronic pad provided by the carrier. The delivery event information is then uploaded to the mail piece tracking system. The delivery event information may include a time that the mail piece requiring special handling was processed, a name of a person receiving the mail piece requiring special handling, a signature of the person receiving the mail piece requiring special handling, a location where the mail piece requiring special handling was received and the like. In one embodiment, the delivery event information is recorded on a single line for easy perusal.

The sender can be notified of the tracking and delivery record for an individual mail piece either via physical and/or electronic channels. In physical notification, the information is obtained from the mail piece tracking system and printed on a postcard for delivery to the sender via the normal mail stream. It should be noted that the physical notification does not require that the destination and return addresses be successfully read. Namely, it is sufficient that the image regions containing the destination address and the return address are identified as such, so that they can be printed in the appropriate location on the notification postcard.

Electronic notification requires that the return address on the mail piece be successfully recognized using OCR (optical character recognition) methods and translated into characters. If it is not successfully recognized by automated means, it is entered manually at existing remote keying stations. In electronic notification, the mail piece tracking system looks up in a database to acquire the e-mail address that corresponds to the return address and sender's name. (The sender's e-mail address will have been previously supplied by the sender during a one-time enrollment process, such as by establishing an online account at a USPS-affiliated web site or by supplying the information at a postal retail outlet.) This electronic notification process would also work if the sender's e-mail address replaces or is added to the return address field.

The delivery information is then sent electronically to the e-mail address. Alternatively, instead of receiving an e-mail message, the sender may access an account on the USPS-affiliated web site and retrieve the electronic notification.

It should be noted that a receipt of mailing which can be generated after step 360, can also be delivered by the same means as that which delivers the delivery event information.

Method 300 ends in step 375. It should be noted that the steps as illustrated in FIG. 3 are broad steps that are typically executed within a mail handling facility. Although method 300 is described as a series of steps, those skilled in the art will realize that these steps are not limited to a specific order, e.g., the special stamp can be canceled after information is extracted and so on.

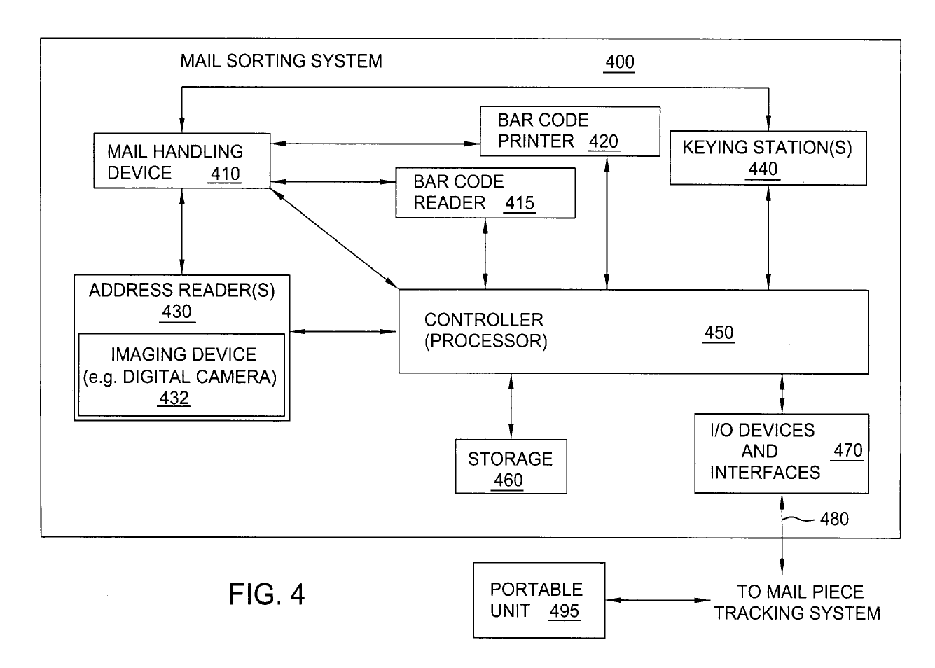

FIG. 4 illustrates a block diagram of a mail sorting system 400 of the present invention. The mail sorting system 400 comprises a mail handling device 410, a bar code reader 415, a bar code printer 420, a keying station 440, one or more address readers 430, a controller 450, a storage 460, and a plurality of Input/Output devices and interfaces 470.

In operation, as mail pieces are rapidly sorted into appropriate bins by the mail-handling device 410, address readers 430 are employed to read the destination address and the return address. It should be noted that the reading of the return address can be implemented as an optional step depending whether special handling services have been detected. In one embodiment, if there is no requirement to “read” the return address, i.e., into text, address reader 430 may comprise a digital camera 432 to simply capture the image of a portion of the mail piece that contains the return address.

Additionally, a bar code reader 415 is optionally tasked with detecting the presence of a special stamp, i.e., reading a bar code using the bar code reader. If the special stamp does not carry a unique code, the address reader's digital imaging device 432 is tasked with identifying the presence of a special stamp, e.g., comparing the captured image with stored imagery. If the presence and type of a special stamp is detected, the bar code printer 420 will print a unique code directly onto the mail piece. If automated recognition means are unable to detect or resolve the addresses or the special stamps, the keying station 440 is used to manually enter the data by postal service employees.

The operations performed by the mail sorting system 400 is controlled by controller 450. The controller 450 serves as the central processor for the overall system. In operation, information (return address, types of special handling service, insurance coverage amount, and so on) pertaining to a mail piece is extracted and stored in a storage 460, e.g., memory, optical disk, disk drive and the like. The mail sorting system may also include a plurality of input/output devices, including by not limited to, a keyboard, a keypad, a mouse, a display, a transmitter, a receiver, and the like. Thus, the mail sorting system 400 is capable of forwarding mail piece information via a communication channel 480 to a mail piece tracking system that may be located remotely from the mail sorting system 400.

Thus, a novel approach for providing special handling services for mail pieces is disclosed that will greatly benefit individuals and small businesses. The approach is hassle free and does not require human interaction or online-interaction for each and every piece of mail.

Although the present invention can be deployed to effect registered mail as disclosed above, delivery of mail via this method may create uncertainty pertaining to the legal force of registered mail unless there is some verification that the mail piece was actually received by the postal service, e.g., at a postal retail outlet. Additionally, since insurance coverage can be offered, the US postal service may require verification that a mail piece was actually deposited into a postal retail outlet, thereby thwarting potential abuses. These concerns are resolved in a second embodiment of the present invention.

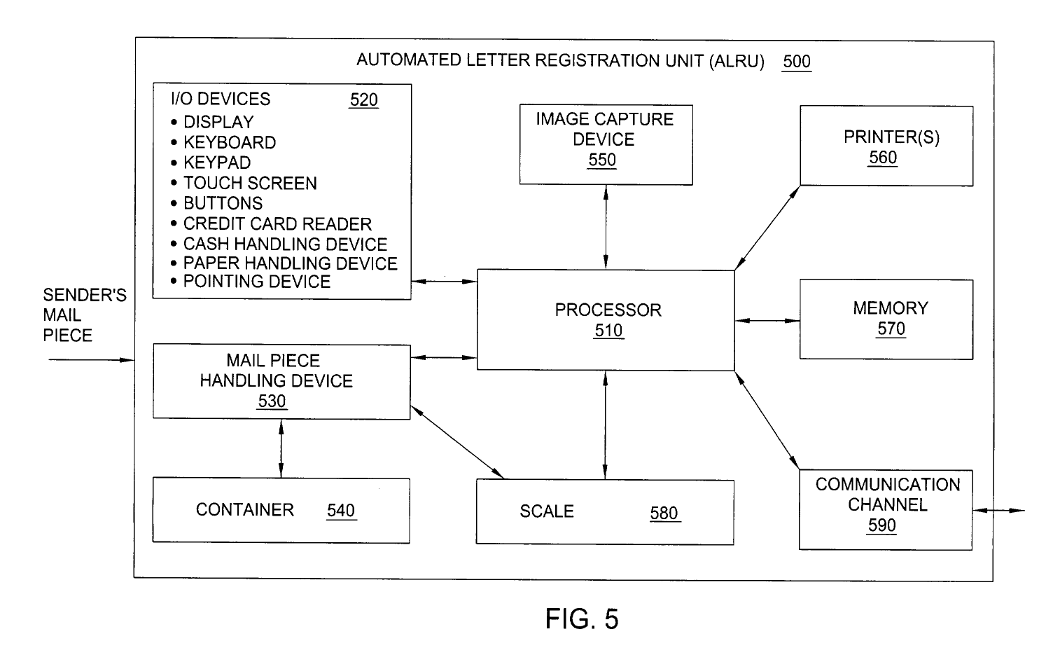

FIG. 5 illustrates a block diagram of an automated mail-piece registration unit (AMRU) 500 of the present invention. The automated mail-piece registration unit comprises a processor 510, Input/Output devices 520, mail piece handling device 530, a secure container 540, an image capturing device 550, one or more printers 560, a memory 570, a scale 580, and a communication channel 590. It should be noted that FIG. 5 illustrates an AMRU having a plurality of components to provide a plurality of features. However, those skilled in the art will realize that some of these components may be omitted to simplify and/or reduce the cost of the deployment of an AMRU as disclosed below.

In brief, FIG. 5 illustrates an AMRU that is a kiosk-like, self-service unit. This automated unit will enable the public at large, both individuals and businesses, to avoid the current time/cost drawbacks by using the AMRU to mail important letters to each other (e.g., mailing original documents, handling landlord/tenant matters, imposing deadlines, paying bills by checks, depositing endorsed checks, asserting claims that need response, transaction of funds, termination of insurance, and law-related matters). Many of these important documents are currently sent by regular mail.

Automating the labor-intensive letter registration will lower its cost. Urban and rural distribution of AMRU's will overcome the time constraint of interacting with a postal employee during normal business hours. These two factors will increase the volume of registered letters, which, in turn, will lower the cost of letter registration even further while increasing the USPS revenues and profits. The present invention describes the functions of the AMRU in the context of registered mail only as an example. It should be noted that the features of registered mail include those of certified mail plus insurance options and foreign country destination. Consistent with the above disclosure, the AMRU can handle all the special handling services as described above.

Returning to FIG. 5, the AMRU is equipped with a plurality of Input/Output devices 520. The Input/Output devices 520 may include but are not limited to a display, a keyboard, a keypad, a touch screen, push buttons, a magnetic card reader, (e.g., a credit card reader), a cash handling device, a paper handling device (e.g., for ejecting a printed receipt), a pointing device (e.g., a mouse) and the like. Again, depending on a particular implementation, some of these I/O devices may be omitted. These I/O devices provide the necessary human-machine interface to allow a sender to interact with the AMRU 500 to effect special handling of a mail piece.

In operation, a mail piece is handled by the mail piece handling device 530 as a letter is inserted into an AMRU 500. The mail piece turns on a switch (or, alternatively, the sender pushes a button), which may trigger two activities inside the AMRU: a digital scale 580 weighs the mail piece and an image capture device 550 takes a picture of the mail piece. The AMRU processor 510 stores the mail piece's image in memory 570, locates the postage stamp(s), meter mark or other indicia within it, determines the value of each of the stamps, computes their sum and compares it to the required postage. If the sum is equal to or larger than the applied postage, the processor 510 commands the built-in printer 560 to print the word “REGISTERED” in a designated area on the mail piece's envelope and to print a receipt for the sender and then commands the paper handling device 520 to eject that receipt. The receipt may consist of a legible photograph of the mail piece's envelope and an imprint including the postage, date, time, and AMRU identification number and/or location.

In case of insufficient postage, the AMRU processor displays the message “Insufficient postage. Needs additional $ . . . ” The sender may then pay the additional cost of the postage by either using a credit card or simply depositing cash into the AMRU. In fact, the sender may use the credit card to pay for the entire required postage (e.g., no stamp on the envelope). This method will be convenient especially for a business organization that may deposit a plurality of registered mail pieces at a single time while paying only once for the entire set of registered mail pieces. After payment is made, the printer 560 will print the postage paid by the credit card or cash near the upper-right corner of the envelope. In some cases, the sender may prefer to either add stamps to the mail piece rather than pay by credit card or cash, or abort the entire mailing process. In either of these cases, a sender presses and a “cancel” button and the processor commands the mail piece handling device 530 to eject the mail piece. The sender may add the needed stamps and reinsert the mail piece into the AMRU 500 to start the letter-registration procedure described above all over again.

The AMRU processor 510 may query the sender, after the letter is inserted into the AMRU but before the letter is weighed, if the sender wants a return receipt, to which the sender responds, using a “Yes” or “No” push button. If the answer is “Yes,” the processor 510 adds the return-receipt charge to the required postage and, after it is paid, adds “Return Receipt Ordered” to the registered recipient and commands the printer 560 to print “RETURN RECEIPT ORDERED” in a designated area on the mail piece.

A similar procedure can be applied for purchasing insurance coverage for a registered mail piece. The AMRU processor may query the sender if he or she wants insurance coverage and, if the answer is yes, the processor will prompt the sender to enter the desired amount of coverage, e.g., using the AMRU keypad 520. The processor will subsequently add the insurance fee to the required postage, add “INSURED FOR $ . . . ” to the receipt and command printer 560 to print “Insured” in a designated area on the mail piece.

The above approach allows a sender to place one mail piece at a time into the AMRU 500. In an alternate “batch” approach, the AMRU will allow the sender to push a button to indicate multiple mail pieces, thereby allowing the sender to sequentially insert several letters into the AMRU. After all the mail pieces are inserted, the sender pushes the button again, and gets one receipt for all the mail pieces. Using this batch approach, every mail piece undergoes the registration procedure described above.

Additional image-processing capabilities can be utilized to find the destination address block of each mail piece, to determine its 9-digit zip code, and to print its POSTNET code on the letter for expediting its handling at the postal center's Automatic Facer/Canceller System (AFCS). The 9-digit ZIP code determined by the AMRU is expected to be more reliable than that determined by the AFCS or other real-time sorting equipment, because more processing time is available, and because the AMRU could display its results and obtain confirmation or corrections from the user. If a letter is mailed to a foreign country, its destination address will be analyzed to determine its assigned postal zip code. The 9-digit zip code may also be included in the printed receipt for verification of zip-code reading and letter-tracking purposes.

The above capabilities can be further expanded by providing a wireless- or cable communication channel 590 between the AMRU and a postal center in order to monitor the AMRU operation and to track each registered letter. The operation of each AMRU may preferentially be monitored remotely by a central system to alert technicians when any repair, maintenance, or resupply is needed.

Tracking a registered letter can be based on information that includes the identification number and/or address of the AMRU, the date and time of the letter-registration procedure, and the 9-digit zip code of the sender and the addressee. This information will be represented (or encrypted) by a single tracking number and its bar code, which will be printed in a designated area on the envelope.

To prevent thefts, all letters received by the AMRU are temporarily stored in a locked, portable, secure container 540. This container will be replaced by an empty one at each collection time and then transferred to a designated postal center, where it will be opened and emptied by only authorized staff. After that, the information collected at the AMRU can be used to automate activities entailed in processing, handling, transporting, and tracking each registered letter along its route from the postal center to the post office that delivers that letter to its recipient.

Electrical power for each AMRU can be provided in different ways, such as using a power cable, electrically rechargeable batteries, and solar batteries. The applicability of each of these power sources will depend on whether the AMRU is in an urban area, a rural area, or a mix of both.

Utilizing different combinations of the above components, several AMRU embodiments with different capabilities can be implemented. The first embodiment is considered to be a basic scheme with several constraints and minimal features. Other subsequent embodiments will then outline feature upgrades that will overcome each of these constraints.

It should be noted that wherever United States Postal Service or USPS is used, it is intended that other mail delivery services, such as FedEx, DHL, and UPS, may employ the present invention. Similarly, wherever “credit-card reader” is used, it is intended to include debit-card and ATM-card readers, smart cards and other such payment means. Further, references to “9-digit ZIP code” is intended to include other postal code systems as assigned by local agencies.

In a first (basic) embodiment, the constraints and features of the AMRU scheme, its components, and the letter-registration procedure entailed in using this scheme are as follows:

Constraints:

1) The required postage is fixed regardless of the letter's weight.

2) No return-receipt option is provided.

3) No insurance-coverage option is provided.

4) Payment for the required postage must be made only with a credit card.

5) The letter's destination address should not be in a foreign country.

6) Only one letter at a time can be inserted and processed by the AMRU.

7) The AMRU does not imprint a POSTNET code on the letter's envelope.

Features:

1) The registration receipt consists of a legible photograph of the letter's envelope and an imprint including the paid postage, date, time, and AMRU identification number and/or location.

2) The AMRU prints the word “REGISTERED” and a letter-tracking bar code on the letter's envelope; the bar-code information includes the identification number and/or address of the AMRU, the letter-registration date and time, and the 9-digit zip codes of the sender and the addressee.

AMRU Components:

1) A regular monitor.

2) A credit-card reader.

3) A CCD camera.

4) A printer.

5) A mail piece handling device.

6) A paper-handling device.

7) A secure container.

8) A processor.

Procedure for the first embodiment:

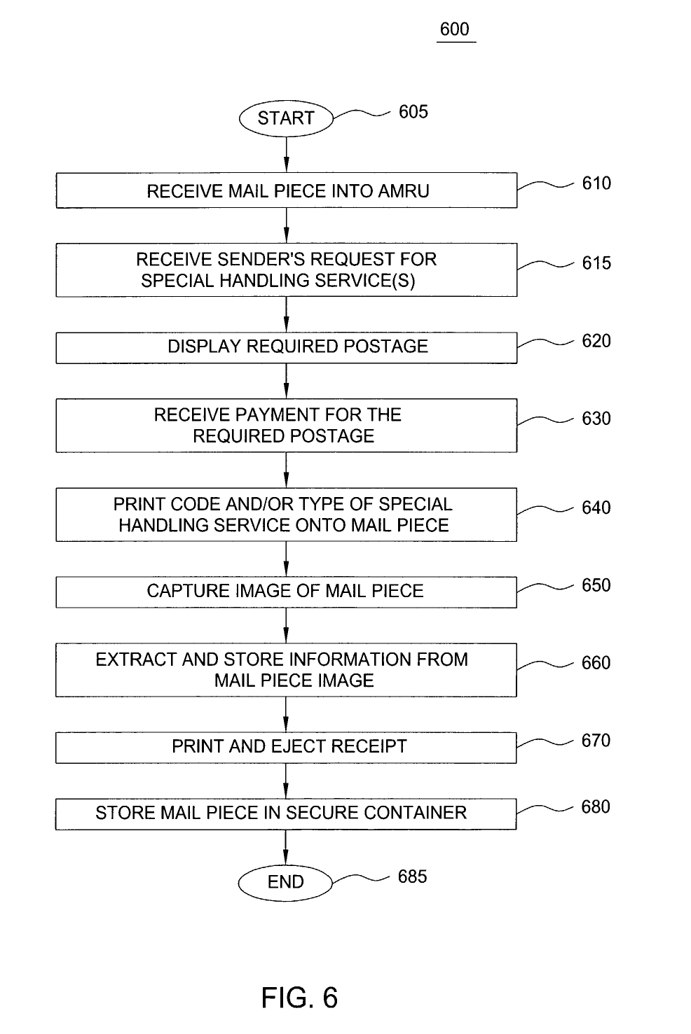

FIG. 6 illustrates a flowchart of a method 600 for handling a mail piece for basic special handling using an AMRU of the present invention. Method 600 starts in step 605 and proceeds to step 610.

In step 610, the AMRU receives a mail piece as the sender inserts a letter into the AMRU slot. Specifically, the mail piece handling mechanism 530 pulls the letter into the AMRU. The physical dimensions of an opening on the AMRU that receives the mail piece can be selected to limit the physical size of an acceptable mail piece that can be deposited into the AMRU.

In step 615, if a plurality of special handling services is offered, then method 600 receives a sender's request for selected handling services(s).

In step 620, a monitor 520 displays the required postage. In this embodiment, the fee for the special handling service can be set fixed. Thus, the processor 510 can immediately display the required postage.

In step 630, the AMRU receives payment for the special handling. For example, the sender pays for it by using his/her credit card or depositing cash. If the credit card is rejected, the mail piece handling device ejects the letter; otherwise, the printer prints the word “REGISTERED” and the letter-tracking bar code on the letter's envelope in step 640.

In step 650, an image of the mail piece or a portion of the mail piece is captured. Specifically, a CCD camera 550 takes a picture of the mail piece.

In step 660, information on the mail piece can be extracted and stored. Namely, information such as return address, a destination address, and the sender's name and/or email address can be extracted from the image of the mail piece, stored, and may be forwarded to a mail tracking system. It should be noted that this processing step can be performed after the transaction is completed with the sender. Namely, step 660 can be applied after step 670 as discussed below.

Alternatively, the above information on each registered mail piece may be subsequently read and processed automatically or manually external to the AMRU. This will allow the complicated and time consuming process of reading information on the mail piece to be performed at a mail facility where processors with greater processing capabilities are deployed.

In step 670, the printer prints a receipt. For example, the receipt, e.g., a registration receipt (see above), may contain a digital image of the envelope plus other pertinent information. The paper-handling device 520 will eject the receipt for the sender.

In step 680, the registered mail piece is stored (together with other registered mail pieces) in a secure container 540 until the mail piece is transported to the postal center and emptied by authorized staff. If the destination address is not in the USA, the mail piece is sent back, with an explanatory note, by regular mail to its sender.

Method 600 ends in step 685. Again, although method 600 is described as a series of steps, those skilled in the art will realize that these steps are not limited to a specific order.

The constraints of the basic AMRU are listed above in an arbitrary order. Several embodiments are now described to have feature upgrades for overcoming each of these constraints. For each upgrade, changes in the constraints and features, the added AMRU components required, and the resulting addition to the letter-registration procedure associated with that upgrade are listed. For brevity, the reader should refer to FIGS. 5 and 6 in view of the disclosure provided below. Namely, the embodiments disclosed below are modifications of the system and method illustrated in FIGS. 5 and 6, respectively. Any components or steps not disclosed in FIGS. 5 and 6 are further described below within each embodiment and are deemed to be incorporated in these FIGs. Additionally, it is certainly possible to implement an AMRU with less components and features that are described in the above basic embodiment to meet the requirement of a particular implementation.

In a second embodiment, the constraints and features of the AMRU scheme, its components, and the mail piece-registration procedure entailed in using this scheme are as follows:

Changes in Features & Constraints are:

1) The required postage depends on the mail piece weight.

Added AMRU Components:

1) A scale.

Added Procedure For the Second Embodiment:

After the mail piece is inserted into the AMRU, the mail piece is weighed. The processor computes the required postage, and the monitor displays that postage.

In a third embodiment, the constraints and features of the AMRU scheme, its components, and the mail piece-registration procedure entailed in using this scheme are as follows:

Changes in Features & Constraints:

1) An optional return-receipt service is provided; if a return receipt is ordered, the statement “Return Receipt Ordered” is printed in a designated area on the letter's envelope and also added to the receipt.

Added AMRU Components:

1) “Yes” and “No” push buttons.

2) Processor and printer capabilities to execute the added features above.

Added Procedure For The Third Embodiment:

After the sender inserts the letter into the AMRU slot, the processor asks the sender via the monitor if he/she wants a return receipt. If the answer is “No,” there is no change in the basic scheme's procedure; otherwise, the processor computes the required postage, including the return-receipt charge, and the monitor displays that postage. After the sender pays for the required postage, the printer prints the statement “RETURN RECEIPT ORDERED” in a designated area on the letter's envelope and subsequently prints a receipt that includes that statement. When the mail pace is delivered, the sender is notified by means of step 370 described above.

In a fourth embodiment, the constraints and features of the AMRU scheme, its components, and the letter-registration procedure entailed in using this scheme are as follows:

Changes in Features & Constraints:

1) An optional insurance coverage is provided; if insurance coverage is ordered, the word “INSURED” is printed in a designated area on the letter's envelope and the statement “Insured for $ . . . ” is added to the receipt.

Added AMRU Components:

1) “Yes” and “No” push buttons and a keyboard.

2) Processor and printer capabilities to execute the added features above.

Added Procedure For The Fourth Embodiment:

After the sender inserts the letter into the AMRU slot, the monitor asks the sender if he or she wants to insure the letter's delivery. If the answer is “No,” there is no change in the basic scheme's procedure; otherwise, the sender uses the keyboard to enter the insurance coverage, the processor computes the required postage, including the insurance-coverage fee, and the monitor displays that postage. After the sender pays for the required postage, the printer prints the word “INSURED” in a designated area on the mail piece and subsequently prints a receipt that includes the statement “Insured for $ . . . ”.

In a fifth embodiment, the constraints and features of the AMRU scheme, its components, and the letter-registration procedure entailed in using this scheme are as follows:

Changes in Features & Constraints:

1) Payment for the required postage may be made using USPS stamps, a credit card, or both.

Added AMRU Components:

1) Yes” and “No” push buttons.

2) Processor capabilities to locate any stamps, determine their total value, and, if it is smaller than the required postage, guide the sender to pay the difference.

Added Procedure For The Fifth Embodiment:

After the sender inserts the mail piece into the AMRU slot, the CCD camera takes a picture of the letter's envelope and the processor stores the envelope's image, finds its upper-right corner, and locates the stamp block near it. If no stamp is found, there is no change in the basic scheme procedure; otherwise, the processor determines the value of each of the stamps and compares their total value to the required postage. If the former is smaller than the latter, the monitor displays the difference and asks the sender if he/she wants to pay it with a credit card. If the answer is “Yes,” the basic scheme procedure is followed; otherwise, the processor commands the mail piece handling mechanism to eject the letter and prompts the sender to add the required stamps and restart the letter-registration procedure.

In a sixth embodiment, the constraints and features of the AMRU scheme, its components, and the letter-registration procedure entailed in using this scheme are as follows:

Changes in Features & Constraints:

1) The mail piece destination address may be anywhere in the world.

Added AMRU Components:

1) “Yes” and “No” push buttons.

2) Image-processing capabilities to recognize the foreign country in the destination address.

Added Procedure For The Sixth Embodiment:

After the sender inserts a letter into the AMRU slot, the processor via the monitor asks the sender if the destination address is domestic. If the answer is “Yes,” there is no change in the basic scheme's procedure; otherwise, the processor finds the destination address block in the mail piece image, identifies the destination-address country, and determines the required postage.

In a seventh embodiment, the constraints and features of the AMRU scheme, its components, and the letter-registration procedure entailed in using this scheme are as follows:

Changes in Features & Constraints:

1) The sender may insert several mail pieces into the AMRU and receive one registration receipt for these mail piece.

Added AMRU Components:

1) “Yes” and “No” push buttons.

2) Processor control of printing one registration receipt for a group of letters.

Added Procedure For The Seventh Embodiment:

The monitor asks the sender if only one mail piece is being registered. If the answer is “Yes,” there is no change in the basic scheme's procedure; otherwise, the sender swipes a credit card (like in a self-service gas station) and inserts several mail pieces, one after the other, into the AMRU slot. Each mail piece is processed in the same way as in the basic scheme, except that no registration receipt is printed. The processor recognizes the last mail piece insertion when the sender presses, say, the No push button or after a set time period elapses with no mail piece insertion. Upon completion, a registration receipt for all the mail pieces are printed and ejected for the sender.

In an eighth embodiment, the constraints and features of the AMRU scheme, its components, and the mail piece-registration procedure entailed in using this scheme are as follows:

Changes in Features & Constraints:

1) The destination-address 9-digit zip code is determined and its POSTNET code is printed on the mail pieces envelope.

Added AMRU Components:

1) Image-processing capability to extract a 9-digit zip code from the image of the destination address and processor/printer capabilities to print a POSTNET code on the mail pieces envelope.

Added Procedure For The Eighth Embodiment:

The processor finds the destination-address block in the image of the mail piece, determines the 9-digit zip code, and commands the printer to print the POSTNET code on the mail piece. (If a letter is mailed to a foreign country, the processor analyzes the destination address and determines its USPS-assigned postal zip code.) As the mail piece arrives at the postal center's AFCS, the mail piece bypasses the OCR process due to the printed POSTNET code.

It should be noted that various systems of the present invention may be implemented using a general purpose computer (e.g., a processor (CPU) with a memory) in conjunction with various input and output devices. Thus, it should be understood that the components and/or steps as described above may be implemented as one or more physical devices that are coupled to the processor through a communication channel. Alternatively, some of these components and/or steps may be represented by one or more software applications (or even a combination of software and hardware, e.g., using application specific integrated circuits (ASIC)), where the software is loaded from a storage medium, (e.g., a magnetic or optical drive or diskette) and operated by the CPU in the memory of the computer. As such, the components and steps (including associated methods and data structures) of the present invention can be stored on a computer readable medium, e.g., RAM memory, magnetic or optical drive or diskette and the like. Additionally, various processes described above may be executed locally within a component or simply passed to the processor for execution depending on the implementation requirement.

Although various embodiments which incorporate the teachings of the present invention have been shown and described in detail herein, those skilled in the art can readily devise many other varied embodiments that still incorporate these teachings.

What is claimed is:

1. Apparatus for processing a mail piece, said apparatus comprising:
means for receiving the mail piece;
means for displaying a required postage for processing the mail piece in accordance with a special handling parameter;
means for receiving a payment;
means for applying a unique code on the mail piece in accordance with said special handling parameter;
means for storing said mail piece; and
means for providing a mailing receipt.

2. The apparatus of claim 1, wherein said apparatus is deployed as a kiosk-like unit.

3. The apparatus of claim 1, wherein said means for receiving a mail piece comprises a mail piece handling device.

4. The apparatus of claim 1, wherein said means for receiving payment is a magnetic card reader or a credit card reader.

5. The apparatus of claim 1, wherein said means for receiving payment is a cash handling device.

6. The apparatus of claim 1, further comprises:
means for interfacing with a user.

7. The apparatus of claim 6, wherein said means for interfacing with a user comprises a touch screen display.

8. The apparatus of claim 6, wherein said means for interfacing with a user comprises a keyboard, a keypad or a plurality of individual keys.

9. The apparatus of claim 1, further comprising:
means for imaging the mail piece.

10. The apparatus of claim 9, wherein said means for imaging comprises a digital camera.

11. The apparatus of claim 10, wherein said receipt comprises an image of the mail piece or a portion of said image of the mail piece.

12. The apparatus of claim 11, wherein said receipt further comprises at least one of the following information: postage, date, time, location and identification number of an automated mail piece registration unit.

13. The apparatus of claim 1, wherein said means for applying a unique code comprises a printer for printing a bar code onto said mail piece.

14. The apparatus of claim 1, wherein said means for applying a unique code comprises a printer for printing a mark indicative of a special handling service.

15. The apparatus of claim 1, further comprising:
a scale for weighing the mail piece to determine said required postage.

16. The apparatus of claim 6, wherein said means for interfacing with a user allows said user to select said special handling parameter, wherein said special handling parameter comprises registered mail, certified mail, insurance coverage, or return receipt.

17. The apparatus of claim 16, wherein said means for interfacing with a user allows the user to select an amount for said insurance coverage.

18. The apparatus of claim 9, wherein said imaging device is used to identify a prepaid postage on said mail piece.

19. The apparatus of claim 18, wherein said imaging device obtains an image of said prepaid postage on the mail piece and analyzes said image for determining a total value of said prepaid postage.

20. The apparatus of claim 19, wherein said means for receiving payment allows additional stamps to be applied to the mail piece.

21. The apparatus of claim 9, where a destination address is extracted from an image of said mail piece.

22. The apparatus of claim 9, where a return address is extracted from said image of said mail piece.

23. The apparatus of claim 9, where a sender name and/or an email address is extracted from said image of said mail piece.

24. The apparatus of claim 9, wherein said image of said mail piece is transmitted to a remote system, wherein a destination address, return address, sender name and/or e-mail address are extracted by said remote system.

25. The apparatus of claim 24, wherein said remote system is a mail piece tracking system.

26. The apparatus of claim 1, wherein said means for receiving the mail piece receives a plurality of mail pieces and wherein said receipt comprises a single receipt that reflects a transaction of said plurality of mail pieces.

27. The apparatus of claim 9, where a zip code of a destination address is extracted from an image of said mail piece.

28. The apparatus of claim 27, wherein said means for applying a unique code applies a POSTNET code on the mail piece.
